(19) United States
(12) Patent Application Publication
(10) Pub. No.: US 2011/0077840 A1
(43) Pub. Date: Mar. 31, 2011

(54) INTERNAL COMBUSTION ENGINE SYSTEM, FUEL INJECTION CONTROL METHOD OF INTERNAL COMBUSTION ENGINE, AND VEHICLE

(75) Inventor: Takahiro Nishigaki, Nagoya-shi (JP)

(73) Assignee: TOYOTA JIDOSHA KABUSHIKI KAISHA, Toyota-Shi (JP)

(21) Appl. No.: 12/883,375

(22) Filed: Sep. 16, 2010

(30) Foreign Application Priority Data
Sep. 25, 2009 (JP) JP2009-220381

(51) Int. Cl. F02M 69/30

(52) U.S. Cl. 701/104

(57) ABSTRACT

The function determination of the air-fuel ratio sensor, including determination whether there occurs the rich-lean abnormality that is an abnormality where the air-fuel ratio sensor becomes less responsive to a change in the air-fuel ratio of the engine from the rich air-fuel ratio to the lean air-fuel ratio, is performed. When the engine is started up with motoring by the motor while the rich-lean abnormality flag F2 is equal to value ‘1’ (S120), the air-fuel ratio feedback correction for fuel injection into the engine is started at a later timing than the timing when the basic start time Tafb elapses from the start of fuel injection (the timing of starting the air-fuel ratio feedback correction when the rich-lean abnormality flag F2 is equal to value ‘1’) after finishing the increase correction at the timing when the increase correction time Tinc elapses from the start of fuel injection (S140 through S240).

### CROSS-REFERENCE TO RELATED APPLICATION

This application claims priority of Japanese Patent Application No. 2009-220381 filed on Sep. 25, 2009, which is incorporated herein by reference in its entirety.

### BACKGROUND OF THE INVENTION

1. Field of the Invention

The present invention relates to an internal combustion engine system, a fuel injection control method of the internal combustion engine system, and a vehicle.

2. Description of the Related Art

In one proposed internal combustion engine system, feedback control of a fuel supply amount is performed to obtain a target air-fuel ratio according to an output from an air-fuel ratio sensor at a restart timing of an internal combustion engine (see, for example, Patent Document 1). In this internal combustion engine system, air-fuel ratio feedback control is started at the restart timing of the internal combustion engine on condition that the output from the air-fuel ratio sensor is within a predetermined air-fuel ratio range, and starting performance of the internal combustion engine is improved in a vehicle, for example, a hybrid vehicle, that has an operation mode to intermit operation of the internal combustion engine. Patent Document 1: Japanese Patent Laid-Open No. 2007-239482

### SUMMARY OF THE INVENTION

In internal combustion engine systems, it is generally required to prevent exhaust emission of an internal combustion engine from becoming worse, for example, by reducing nitrogen oxides (NOx) at a start timing of the internal combustion engine. In such a sensor as an air-fuel ratio sensor, there is a case where responsiveness of the sensor is reduced or an output of the sensor indicates an abnormal value. It is so required to make determination of a sensor function to reflect the result of the function determination on control.

In the internal combustion engine system, a fuel injection control method of the internal combustion engine system, and a vehicle of the invention, the main object of the invention is to prevent exhaust emission from becoming worse using the result of function determination of an air-fuel ratio detector unit when an internal combustion engine is started up.

In order to attain the main object, the internal combustion engine system, the fuel injection control method of the internal combustion engine system, and the vehicle of the invention have the configurations discussed below.

According to one aspect, the present invention is directed to an internal combustion engine system. The internal combustion engine system, having an internal combustion engine and a motor capable of cranking the internal combustion engine, the internal combustion engine system has: a fuel injector that performs fuel injection into the internal combustion engine; an air-fuel ratio detector that detects an air-fuel ratio of the internal combustion engine; an air-fuel ratio detecting function determination module that performs function determination of the air-fuel ratio detector, the function determination including detection of a responsiveness reduction abnormality that is an abnormality where the air-fuel ratio detector becomes less responsive to a change in the air-fuel ratio of the internal combustion engine from a rich air-fuel ratio to a lean air-fuel ratio, the rich air-fuel ratio being fuel-richer and the lean air-fuel ratio being fuel-leaner both in comparison with a stoichiometric air-fuel ratio; a target fuel injection amount setting module that, when the internal combustion engine is cranked by the motor and started up while the responsiveness reduction abnormality is not detected, sets a target fuel injection amount to be injected into the internal combustion engine by applying an increase correction to a basic fuel injection amount until a preset timing that is predetermined so that the internal combustion engine is favorably combusted, the basic fuel injection amount being a fuel injection amount based on an intake air amount of the internal combustion engine for bringing the air-fuel ratio of the internal combustion engine to the stoichiometric air-fuel ratio, and then sets the target fuel injection amount by performing an air-fuel ratio feedback correction from a first start timing that is predetermined as a timing when the detected air-fuel ratio by the air-fuel ratio detector reaches a target air-fuel ratio range including the stoichiometric air-fuel ratio without occurrence of the responsiveness reduction abnormality after finishing the increase correction, the air-fuel ratio feedback correction being a correction of the basic fuel injection amount using feedback control for bringing the detected air-fuel ratio by the air-fuel ratio detector to the stoichiometric air-fuel ratio, and when the internal combustion engine is cranked by the motor and started up while the responsiveness reduction abnormality is detected, the target fuel injection amount setting module setting the target fuel injection amount by applying the increase correction to the basic fuel injection amount until the preset timing, and then setting the target fuel injection amount by performing the air-fuel ratio feedback correction from a second start timing that is later than the first start timing; and a fuel injection control module that controls the fuel injector so that the fuel injection into the internal combustion engine is performed according the set target fuel injection amount.

The internal combustion engine system according to this aspect of the invention, performs function determination of the air-fuel ratio detector, the function determination including detection of a responsiveness reduction abnormality that is an abnormality where the air-fuel ratio detector becomes less responsive to a change in the air-fuel ratio of the internal combustion engine from a rich air-fuel ratio to a lean air-fuel ratio, the rich air-fuel ratio being fuel-richer and the lean air-fuel ratio being fuel-leaner both in comparison with a stoichiometric air-fuel ratio. When the internal combustion engine is cranked by the motor and started up while the responsiveness reduction abnormality is not detected, the system sets a target fuel injection amount to be injected into the internal combustion engine by applying an increase correction to a basic fuel injection amount until a preset timing that is predetermined so that the internal combustion engine is favorably combusted, the basic fuel injection amount being a fuel injection amount based on an intake air amount of the internal combustion engine for bringing the air-fuel ratio of the internal combustion engine to the stoichiometric air-fuel ratio, and then sets the target fuel injection amount by performing an air-fuel ratio feedback correction from a first start timing that is predetermined as a timing when the detected air-fuel ratio by the air-fuel ratio detector reaches a target air-fuel ratio range including the stoichiometric air-fuel ratio without occurrence of the responsiveness reduction abnormality after finishing the increase correction, the air-fuel ratio feedback correction being a correction of the basic fuel injection amount using feedback control for bringing the detected air-fuel ratio by the air-fuel ratio detector to the stoichiometric air-fuel ratio. When the internal combustion engine is cranked by the motor and started up while the responsiveness reduction abnormality is detected, the system sets the target fuel injection amount by applying the increase correction to the basic fuel injection amount until the preset timing, and then sets the target fuel injection amount by performing the air-fuel ratio feedback correction from a second start timing that is later than the first start timing. And the system controls the fuel injector so that the fuel injection into the internal combustion engine is performed according the set target fuel injection amount. When the internal combustion engine is started up while the responsiveness reduction abnormality is detected, the detected air-fuel ratio by the air-fuel ratio detector reaches the target air-fuel ratio range which includes the stoichiometric air-fuel ratio from the rich air-fuel ratio at a later timing than the first start timing. When the internal combustion engine is started up while the responsiveness reduction abnormality is detected, the air-fuel ratio feedback control is performed from the second start timing later than the first start timing. Accordingly, it is prevented to decrease the fuel injection amount into the internal combustion engine from a fuel injection amount corresponding to the stoichiometric air-fuel ratio at the start timing of the air-fuel ratio feedback correction. As a result, this arrangement effectively prevents exhaust emission from becoming worse using the result of function determination of the air-fuel ratio detector when the internal combustion engine is started up.

In one preferable application of the internal combustion engine system of the invention, the air-fuel ratio detecting function determination module may detect a reduced degree of responsiveness of the air-fuel ratio detector as a delay time upon the detection of the responsiveness reduction abnormality, and the target fuel injection amount setting module may set, when the internal combustion engine is cranked by the motor and started up while the responsiveness reduction abnormality is detected, the target fuel injection amount using a later timing by a corresponding time to the detected delay time than the first start timing as the second start timing. This arrangement more appropriately prevents exhaust emission from becoming worse using the result of function determination of the air-fuel ratio detector when the internal combustion engine is started up.

According to another aspect, the present invention is directed to a vehicle having any of the above arrangements of the internal combustion engine system and a second motor capable of outputting power for driving the vehicle, the vehicle being driven with an intermittent operation of the internal combustion engine. Here the internal combustion engine system having an internal combustion engine and a motor capable of cranking the internal combustion engine, fundamentally has: a fuel injector that performs fuel injection into the internal combustion engine; an air-fuel ratio detector that detects an air-fuel ratio of the internal combustion engine; an air-fuel ratio detecting function determination module that performs function determination of the air-fuel detector, the function determination including detection of a responsiveness reduction abnormality that is an abnormality where the air-fuel ratio detector becomes less responsive to a change in the air-fuel ratio of the internal combustion engine from a rich air-fuel ratio to a lean air-fuel ratio, the rich air-fuel ratio being fuel-richer and the lean air-fuel ratio being fuel-leaner both in comparison with a stoichiometric air-fuel ratio; a target fuel injection amount setting module that, when the internal combustion engine is cranked by the motor and started up while the responsiveness reduction abnormality is not detected, sets a target fuel injection amount to be injected into the internal combustion engine by applying an increase correction to a basic fuel injection amount until a preset timing that is predetermined so that the internal combustion engine is favorably combusted, the basic fuel injection amount being a fuel injection amount based on an intake air amount of the internal combustion engine for bringing the air-fuel ratio of the internal combustion engine to the stoichiometric air-fuel ratio, and then sets the target fuel injection amount by performing an air-fuel ratio feedback correction from a first start timing that is predetermined as a timing when the detected air-fuel ratio by the air-fuel ratio detector reaches a target air-fuel ratio range including the stoichiometric air-fuel ratio without occurrence of the responsiveness reduction abnormality after finishing the increase correction, the air-fuel ratio feedback correction being a correction of the basic fuel injection amount using feedback control for bringing the detected air-fuel ratio by the air-fuel ratio detector to the stoichiometric air-fuel ratio, and when the internal combustion engine is cranked by the motor and started up while the responsiveness reduction abnormality is detected, the target fuel injection amount setting module setting the target fuel injection amount by applying the increase correction to the basic fuel injection amount until the preset timing, and then setting the target fuel injection amount by performing the air-fuel ratio feedback correction from a second start timing that is later than the first start timing; and a fuel injection control module that controls the fuel injector so that the fuel injection into the internal combustion engine is performed according the set target fuel injection amount.

The vehicle according to this aspect of the invention has any of the above arrangements of the internal combustion engine system. The vehicle thus has at least part of effects that the internal combustion engine system of the invention has such as an effect of preventing exhaust emission from becoming worse using the result of function determination of the air-fuel ratio detector when the internal combustion engine is started up.

According to still another aspect, the present invention is directed to a fuel injection control method of an internal combustion engine in an internal combustion engine system having the internal combustion engine, a fuel injector that performs fuel injection into the internal combustion engine, an air-fuel ratio detector that detects an air-fuel ratio of the internal combustion engine, and a motor capable of cranking the internal combustion engine. The fuel injection control method includes: performing function determination of the air-fuel ratio detector, the function determination including detection of a responsiveness reduction abnormality that is an abnormality where the air-fuel ratio detector becomes less responsive to a change in the air-fuel ratio of the internal combustion engine from a rich air-fuel ratio to a lean air-fuel ratio, the rich air-fuel ratio being fuel-richer and the lean air-fuel ratio being fuel-leaner both in comparison with a stoichiometric air-fuel ratio; when the internal combustion engine is cranked by the motor and started up while the responsiveness reduction abnormality is not detected, setting a target fuel injection amount to be injected into the internal combustion engine by applying an increase correction to a basic fuel injection amount until a preset timing that is predetermined so that the internal combustion engine is favorably combusted, the basic fuel injection amount being a fuel injection amount based on an intake air amount of the internal combustion engine for bringing the air-fuel ratio of the internal combustion engine to the stoichiometric air-fuel ratio, and then setting the target fuel injection amount by performing an air-fuel ratio feedback correction from a first start timing that is predetermined as a timing when the detected air-fuel ratio by the air-fuel ratio detector reaches a target air-fuel ratio range including the stoichiometric air-fuel ratio without occurrence of the responsiveness reduction abnormality after finishing the increase correction, the air-fuel ratio feedback correction being a correction of the basic fuel injection amount using feedback control for bringing the detected air-fuel ratio by the air-fuel ratio detector to the stoichiometric air-fuel ratio, and when the internal combustion engine is cranked by the motor and started up while the responsiveness reduction abnormality is detected, setting the target fuel injection amount by applying the increase correction to the basic fuel injection amount until the preset timing, and then setting the target fuel injection amount by performing the air-fuel ratio feedback correction from a second start timing that is later than the first start timing; and controlling the fuel injector so that the fuel injection into the internal combustion engine is performed according the set target fuel injection amount.

The fuel injection control method of the internal combustion engine according to this aspect of the invention, performs function determination of the air-fuel ratio detector, the function determination including detection of a responsiveness reduction abnormality that is an abnormality where the air-fuel ratio detector becomes less responsive to a change in the air-fuel ratio of the internal combustion engine from a rich air-fuel ratio to a lean air-fuel ratio, the rich air-fuel ratio being fuel-richer and the lean air-fuel ratio being fuel-leaner both in comparison with a stoichiometric air-fuel ratio. When the internal combustion engine is cranked by the motor and started up while the responsiveness reduction abnormality is not detected, the method sets a target fuel injection amount to be injected into the internal combustion engine by applying an increase correction to a basic fuel injection amount until a preset timing that is predetermined so that the internal combustion engine is favorably combusted, the basic fuel injection amount being a fuel injection amount based on an intake air amount of the internal combustion engine for bringing the air-fuel ratio of the internal combustion engine to the stoichiometric air-fuel ratio, and then sets the target fuel injection amount by performing an air-fuel ratio feedback correction from a first start timing that is predetermined as a timing when the detected air-fuel ratio by the air-fuel ratio detector reaches a target air-fuel ratio range including the stoichiometric air-fuel ratio without occurrence of the responsiveness reduction abnormality after finishing the increase correction, the air-fuel ratio feedback correction being a correction of the basic fuel injection amount using feedback control for bringing the detected air-fuel ratio by the air-fuel ratio detector to the stoichiometric air-fuel ratio. When the internal combustion engine is cranked by the motor and started up while the responsiveness reduction abnormality is detected, the method sets the target fuel injection amount by applying the increase correction to the basic fuel injection amount until the preset timing, and then sets the target fuel injection amount by performing the air-fuel ratio feedback correction from a second start timing that is later than the first start timing. And the method controls the fuel injector so that the fuel injection into the internal combustion engine is performed according the set target fuel injection amount. When the internal combustion engine is started up while the responsiveness reduction abnormality is detected, the air-fuel ratio feedback control is performed from the second start timing later than the first start timing. Accordingly, it is prevented to decrease the fuel injection amount into the internal combustion engine from a fuel injection amount corresponding to the stoichiometric air-fuel ratio at the start timing of the air-fuel ratio feedback correction. As a result, this arrangement effectively prevents exhaust emission from becoming worse using the result of function determination of the air-fuel ratio detector when the internal combustion engine is started up.

### BRIEF DESCRIPTION OF THE DRAWINGS

FIG. 1 schematically illustrates the configuration of a hybrid vehicle 20 in one embodiment of the invention;

FIG. 2 is a schematic view showing the structure of an engine 22;

FIG. 3 shows one set of examples of output characteristics of an air-fuel ratio sensor 135a and an oxygen sensor 135b;

FIG. 4 is a flowchart showing a startup time fuel injection control routine executed by an engine ECU 24 in the embodiment;

FIG. 5 is a flowchart showing a function determination routine executed by the engine ECU 24 in the embodiment;

FIG. 6 shows one set of examples of time charts of an oxygen signal Vo and an air-fuel ratio Vaf during execution of function determination of the air-fuel ratio sensor 135a;

FIG. 7 shows one set of examples of time charts of an air-fuel ratio of an engine 22;

FIG. 8 schematically illustrates the configuration of another hybrid vehicle 120 in one modified example; and

FIG. 9 schematically illustrates the configuration of still another hybrid vehicle 220 in another modified example.

### DETAILED DESCRIPTION OF THE PREFERRED EMBODIMENTS

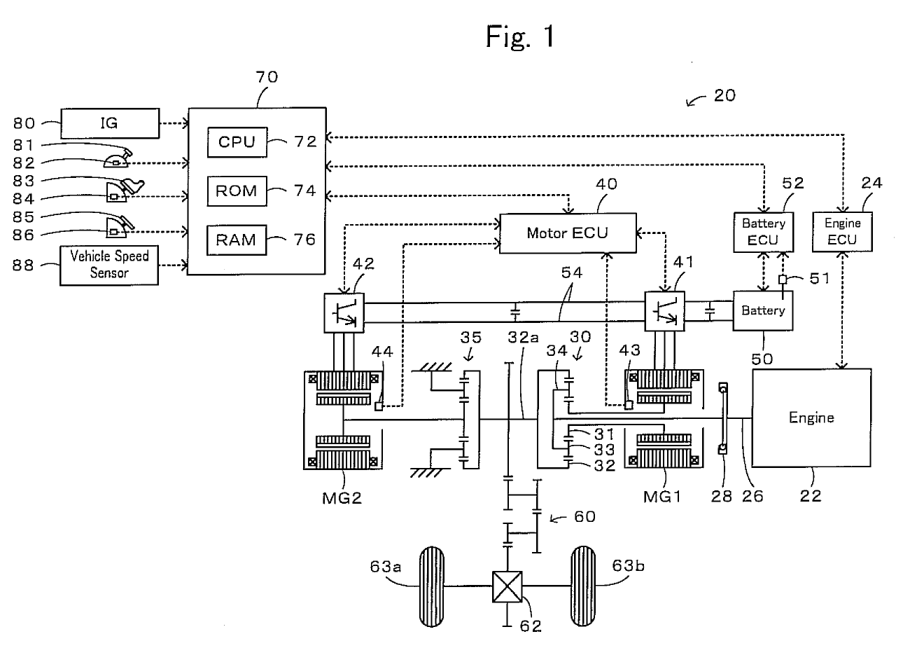

One mode of carrying out the invention is discussed below as a preferred embodiment. FIG. 1 schematically illustrates the configuration of a hybrid vehicle 20 in one embodiment according to the invention. As illustrated, the hybrid vehicle 20 of the embodiment includes the engine 22, a three shaft-type power distribution integration mechanism 30 connected via a damper 28 to a crankshaft 26 or an output shaft of the engine 22, a motor MG1 connected to the power distribution integration mechanism 30 and designed to have power generation capability, a reduction gear 35 attached to a ring gear shaft 32a or a driveshaft linked with the power distribution integration mechanism 30, a motor MG2 connected to the reduction gear 35, and a hybrid electronic control unit 70 configured to control the operations of the whole hybrid vehicle 20.

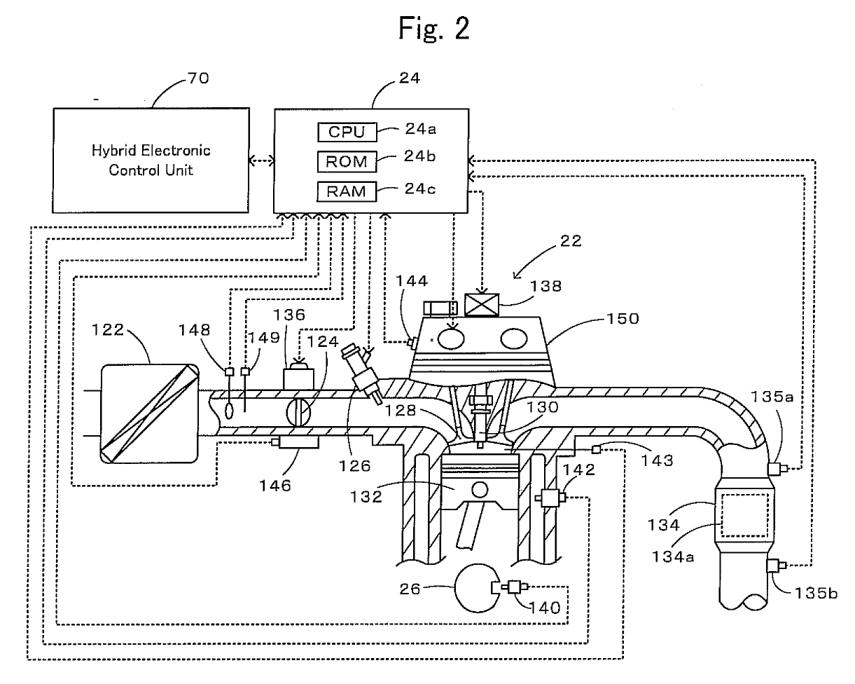

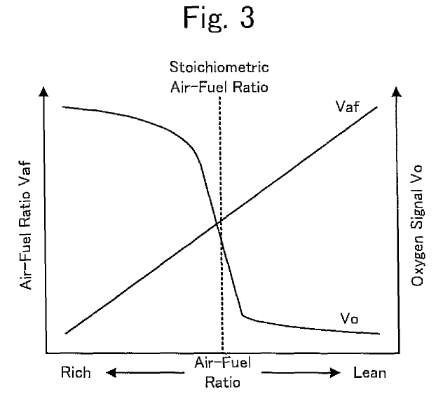

The engine 22 is an internal combustion engine that consumes a hydrocarbon fuel, such as gasoline or light oil, to output power. As shown in FIG. 2, the air cleaned by an air cleaner 122 and taken into an air intake conduit via a throttle valve 124 is mixed with the atomized fuel injected from a fuel injection valve 126 to the air-fuel mixture. The air-fuel mixture is introduced into a combustion chamber by means of an intake valve 128. The introduced air-fuel mixture is ignited with spark made by a spark plug 130 to be explosively combusted. The reciprocating motions of a piston 132 pressed down by the combustion energy are converted into rotational motions of the crankshaft 26. The exhaust from the engine 22 goes through a catalytic converter 134 having a three-way catalyst 134a to convert toxic components included in the exhaust, that is, carbon monoxide (CO), hydrocarbons (HC), and nitrogen oxides (NOx), into harmless components, and is discharged to the outside air. At the three-way catalyst 134a, oxygen is occluded from the exhaust of the engine 22 when the exhaust makes a fuel-leaner atmosphere than a stoichiometric atmosphere, and the occluded oxygen is released to the exhaust of the engine 22 when the exhaust makes a fuel-richer atmosphere than the stoichiometric atmosphere. An air-fuel ratio sensor 135a that output value varies linearly according to the air-fuel ratio is mounted at an upstream side of the catalytic converter 134, and an oxygen sensor 135b that output value abruptly varies according to whether the air-fuel ratio is at a rich or lean side of the stoichiometric atmosphere is mounted at an downstream side of the catalytic converter 134. FIG. 3 shows one set of examples of output characteristics of the air-fuel ratio sensor 135a and the oxygen sensor 135b.

The engine 22 is under control of an engine electronic control unit (hereafter referred to as engine ECU) 24. The engine ECU 24 is constructed as a microprocessor including a CPU 24a, a ROM 24b configured to store processing programs, a RAM 24c configured to temporarily store data, input and output ports (not shown), and a communication port (not shown). The engine ECU 24 receives, via its input port, signals from various sensors designed to measure and detect the operating conditions of the engine 22. The signals input into the engine ECU 24 include a crank position from a crank position sensor 140 detected as the rotational position of the crankshaft 26, a cooling water temperature Tw from a water temperature sensor 142 measured as the temperature of cooling water in the engine 22, an in-cylinder pressure from a pressure sensor 142 located inside the combustion chamber, cam positions from a cam position sensor 144 detected as the rotational positions of camshafts driven to open and close the intake valve 128 and an exhaust valve for gas intake and exhaust into and from the combustion chamber, a throttle position Ta from a throttle valve position sensor 146 detected as the position of the throttle valve 124, an intake air amount Qa from an air flow meter 148 located in an air intake conduit, an intake air temperature Ti from a temperature sensor 149 located in the air intake conduit, an air-fuel ratio Vaf from the air-fuel ratio sensor 135a, and an oxygen signal Vo from the oxygen sensor 135b. The engine ECU 24 outputs, via its output port, diverse control signals and driving signals to drive and control the engine 22. The signals output from the engine ECU 24 include driving signals to the fuel injection valve 126, driving signals to a throttle valve motor 136 driven to regulate the position of the throttle valve 124, control signals to an ignition coil 138 integrated with an igniter, and control signals to a variable valve timing mechanism 150 to vary the open and close timings of the intake valve 128. The engine ECU 24 establishes communication with the hybrid electronic control unit 70 to drive and control the engine 22 in response to control signals received from the hybrid electronic control unit 70 and to output data regarding the operating conditions of the engine 22 to the hybrid electronic control unit 70 according to the requirements. The engine ECU 24 also performs several arithmetic operations to compute a rotation speed of the crankshaft 26 or a rotation speed Ne of the engine 22 from the crank position input from the crank position sensor 140.

The power distribution integration mechanism 30 has a sun gear 31 that is an external gear, a ring gear 32 that is an internal gear and is arranged concentrically with the sun gear 31, multiple pinion gears 33 that engage with the sun gear 31 and with the ring gear 32, and a carrier 34 that holds the multiple pinion gears 33 in such a manner as to allow free revolution thereof and free rotation thereof on the respective axes. Namely the power distribution integration mechanism 30 is constructed as a planetary gear mechanism that allows for differential motions of the sun gear 31, the ring gear 32, and the carrier 34 as rotational elements. The carrier 34, the sun gear 31, and the ring gear 32 in the power distribution integration mechanism 30 are respectively coupled with the crankshaft 26 of the engine 22, the motor MG1, and the reduction gear 35 via ring gear shaft 32a. While the motor MG1 functions as a generator, the power output from the engine 22 and input through the carrier 34 is distributed into the sun gear 31 and the ring gear 32 according to the gear ratio. While the motor MG1 functions as a motor, on the other hand, the power output from the engine 22 and input through the carrier 34 is combined with the power output from the motor MG1 and input through the sun gear 31 and the composite power is output to the ring gear 32. The power output to the ring gear 32 is thus finally transmitted to the driving wheels 63a and 63b via the gear mechanism 60, and the differential gear 62 from ring gear shaft 32a.

Both the motors MG1 and MG2 are known synchronous motor generators that are driven as a generator and as a motor. The motors MG1 and MG2 transmit electric power to and from a battery 50 via inverters 41 and 42. Power lines 54 that connect the inverters 41 and 42 with the battery 50 are constructed as a positive electrode bus line and a negative electrode bus line shared by the inverters 41 and 42. This arrangement enables the electric power generated by one of the motors MG1 and MG2 to be consumed by the other motor. The battery 50 is charged with a surplus of the electric power generated by the motor MG1 or MG2 and is discharged to supplement an insufficiency of the electric power. When the power balance is attained between the motors MG1 and MG2, the battery 50 is neither charged nor discharged. Operations of both the motors MG1 and MG2 are controlled by a motor electronic control unit (hereafter referred to as motor ECU) 40. The motor ECU 40 receives diverse signals required for controlling the operations of the motors MG1 and MG2, for example, signals from rotational position detection sensors 43 and 44 that detect the rotational positions of rotors in the motors MG1 and MG2 and phase currents applied to the motors MG1 and MG2 and measured by current sensors (not shown). The motor ECU 40 outputs switching control signals to the inverters 41 and 42. The motor ECU 40 communicates with the hybrid electronic control unit 70 to control operations of the motors MG1 and MG2 in response to control signals transmitted from the hybrid electronic control unit 70 while outputting data relating to the operating conditions of the motors MG1 and MG2 to the hybrid electronic control unit 70 according to the requirements. The motor ECU 40 also performs arithmetic operations to compute rotation speeds Nm1 and Nm2 of the motors MG1 and MG2 from the output signals of the rotational position detection sensors 43 and 44.

The battery 50 is under control of a battery electronic control unit (hereafter referred to as battery ECU) 52. The battery ECU 52 receives diverse signals required for control of the battery 50, for example, an inter-terminal voltage measured by a voltage sensor (not shown) disposed between terminals of the battery 50, a charge-discharge current measured by a current sensor (not shown) attached to the power line 54 connected with the output terminal of the battery 50, and a battery temperature Tb measured by a temperature sensor 51 attached to the battery 50. The battery ECU 52 outputs data relating to the state of the battery 50 to the hybrid electronic control unit 70 via communication according to the requirements. The battery ECU 52 also performs various arithmetic operations for management and control of the battery 50. A remaining charge or state of charge (SOC) of the battery 50 is calculated from an integrated value of the charge-discharge current measured by the current sensor. An input limit Win as an allowable charging electric power to be charged in the battery 50 and an output limit Wout as an allowable discharging electric power to be discharged from the battery 50 are set corresponding to the calculated state of charge (SOC) and the battery temperature Tb. A concrete procedure of setting the input and output limits Win and Wout of the battery 50 sets base values of the input limit Win and the output limit Wout corresponding to the battery temperature Tb, specifies an input limit correction factor and an output limit correction factor corresponding to the state of charge (SOC) of the battery 50, and multiplies the base values of the input limit Win and the output limit Wout by the specified input limit correction factor and output limit correction factor to determine the input limit Win and the output limit Wout of the battery 50.

The hybrid electronic control unit 70 is constructed as a microprocessor including a CPU 72, a ROM 74 that stores processing programs, a RAM 76 that temporarily stores data, and a non-illustrated input-output port, and a non-illustrated communication port. The hybrid electronic control unit 70 receives various inputs via the input port: an ignition signal from an ignition switch 80, a gearshift position SP from a gearshift position sensor 82 that detects the current position of a gearshift lever 81, an accelerator opening Acc from an accelerator pedal position sensor 84 that measures a step-on amount of an accelerator pedal 83, a brake pedal position BP from a brake pedal position sensor 86 that measures a step-on amount of a brake pedal 85, and a vehicle speed V from a vehicle speed sensor 88. The hybrid electronic control unit 70 communicates with the engine ECU 24, the motor ECU 40, and the battery ECU 52 via the communication port to transmit diverse control signals and data to and from the engine ECU 24, the motor ECU 40, and the battery ECU 52, as mentioned previously.

The hybrid vehicle 20 of the embodiment thus constructed calculates a torque demand to be output to the ring gear shaft 32a functioning as the drive shaft, based on observed values of a vehicle speed V and an accelerator opening Acc, which corresponds to a driver's step-on amount of the accelerator pedal 83. The engine 22 and the motors MG1 and MG2 are subjected to operation control to output a required level of power corresponding to the calculated torque demand to the ring gear shaft 32a. The operation control of the engine 22 and the motors MG1 and MG2 selectively effectuates one of a torque conversion drive mode, a charge-discharge drive mode, and a motor drive mode. The torque conversion drive mode controls the operations of the engine 22 to output a quantity of power equivalent to the required level of power, while driving and controlling the motors MG1 and MG2 to cause all the power output from the engine 22 to be subjected to torque conversion by means of the power distribution integration mechanism 30 and the motors MG1 and MG2 and output to the ring gear shaft 32a. The charge-discharge drive mode controls the operations of the engine 22 to output a quantity of power equivalent to the sum of the required level of power and a quantity of electric power consumed by charging the battery 50 or supplied by discharging the battery 50, while driving and controlling the motors MG1 and MG2 to cause all or part of the power output from the engine 22 equivalent to the required level of power to be subjected to torque conversion by means of the power distribution integration mechanism 30 and the motors MG1 and MG2 and output to the ring gear shaft 32a, simultaneously with charge or discharge of the battery 50. The motor drive mode stops the operations of the engine 22 and drives and controls the motor MG2 to output a quantity of power equivalent to the required level of power to the ring gear shaft 32a. Both of the torque conversion drive mode and the charge-discharge drive mode are modes for controlling the engine 22 and the motors MG1 and MG2 to output the required level of power to the ring gear shaft 32a with operation of the engine 22 and the control in the both modes practically has no difference. A combination of the both modes is thus referred to as an engine drive mode hereafter.

In the engine drive mode, the hybrid electronic control unit 70 sets a torque demand Tr* to be output to the ring gear shaft 32a or the driveshaft based on the accelerator opening Acc and the vehicle speed V, and sets a power demand Pe* required for the engine 22 by subtracting a charging power that the battery 50 requires from a driving power that is obtained as the required level of power from the product of the set torque demand Tr* and a rotation speed Nr of the ring gear shaft 32a. The charging power is positive when the battery 50 is discharged. The rotation speed Nr of the ring gear shaft 32a is obtained by dividing the rotation speed Nm2 of the motor MG2 by a gear ratio Gr of the reduction gear 35 or by multiplying the vehicle speed V by a conversion factor. The hybrid electronic control unit 70 then sets a target rotation speed Ne* and a target torque Te* based on the set power demand Pe* so that the engine 22 is efficiently operated and sends the settings of the target rotation speed Ne* and the target torque Te* to the engine ECU 24. The hybrid electronic control unit 70 also sets a torque command Tm1* of the motor MG1 so that the engine 22 is rotated at the target rotation speed Ne*, sets a torque command Tm2* of the motor MG2 within a range of the input limit Win and the output limit Wout of the battery 50 so that the hybrid vehicle 20 is driven with the torque demand Tr*, and sends the settings of the torque command Tm1* and Tm2* of the motor MG1 and MG2 to the motor ECU 40. In response to reception of the settings of the target rotation speed Ne* and the target torque Te*, the engine ECU 24 performs required controls including intake air flow regulation, ignition control, and fuel injection control of the engine 22 to drive the engine 22 at the specific drive point defined by the combination of the target rotation speed Ne* and the target torque Te*. In response to reception of the settings of the torque commands Tm1* and Tm2*, the motor ECU 40 performs switching control of the switching elements in the inverter 41 and the switching elements in the inverter 42 to drive the motor MG1 with the torque command Tm1* and the motor MG2 with the torque command Tm2*. In the motor drive mode, the hybrid electronic control unit 70 sets the torque command Tm2* of the motor MG2 within the range of the input limit Win and the output limit Wout of the battery 50 to output the torque demand Tr* based on the accelerator opening Acc and the vehicle speed V to the ring gear shaft 32a or the driveshaft, and sends the setting of the torque command Tm2* to the motor ECU 40. In response to reception of the setting of the torque command Tm2*, the motor ECU 40 performs switching control of the switching elements in the inverter 42 to drive the motor MG2 with the torque command Tm2*. Switching between the engine drive mode and the motor drive mode is done by comparing the power demand Pe* with a starting threshold value for startup of the engine 22 and with a stopping threshold value for operation stop of the engine 22. When the power demand Pe* becomes lower than the stopping threshold value to satisfy a stop condition during the engine drive mode, the engine drive mode is switched to the motor drive mode by stopping operation of the engine 22. When the power demand Pe* becomes higher than the starting threshold value to satisfy a startup condition during the motor drive mode, the motor drive mode is switched to the engine drive mode by starting up the engine 22. According to the above control, the hybrid vehicle 20 of the embodiment is driven with outputting the torque demand Tr* corresponding to the accelerator opening Acc to the ring gear shaft 32a or the driveshaft with charge and discharge of the battery 50 while performing an intermittent operation of the engine 22.

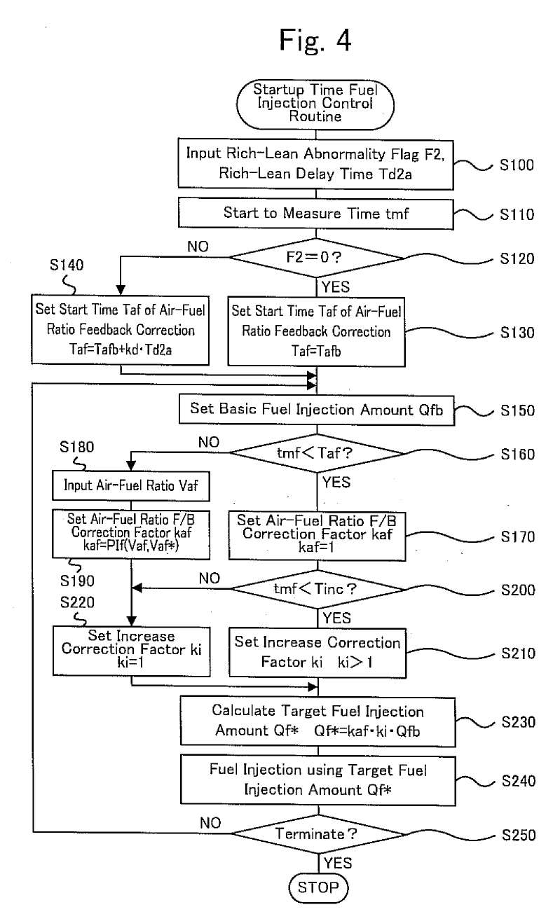

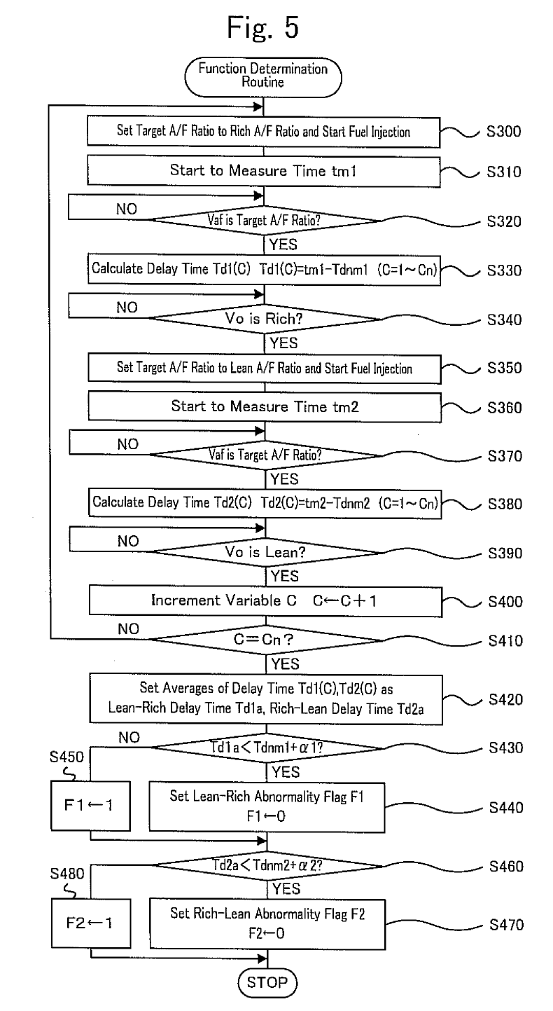

The description regards the operations of the hybrid vehicle 20 of the embodiment having the configuration discussed above, especially a series of operation control for startup of the engine 22 while driving the hybrid vehicle 20 with the intermittent operation of the engine 22. FIG. 4 is a flowchart showing a startup time fuel injection control executed by the engine ECU 24 to start up the engine 22, and FIG. 5 is a flowchart showing a function determination routine executed by the engine ECU 24 to obtain a result of function determination of the air-fuel ratio sensor 135a. The result of function determination is used for the startup time fuel injection. Starting up the engine 22 is done by motoring the engine 22 with outputting a motoring torque for motoring (cranking) the engine 22 from the motor MG1 and with receiving the action of the motoring torque by an output torque of the motor MG2, and done by starting fuel injection from the fuel injection valve 126 and ignition at the spark plug 130 when the rotation speed Ne of the engine 22 reaches a preset rotation speed for starting the fuel injection and the ignition. Motoring the engine 22 is done by setting the motoring torque as the torque command Tm1* of the motor MG1 and sending the setting of the torque command Tm1* to the motor ECU 40 by the hybrid electronic control unit 70, and done by performing switching control of the inverter 41 to output a corresponding torque to the torque command Tm1* from the motor MG1 by the motor ECU 40 that received the setting of the torque command Tm1*. The function determination of the air-fuel ratio sensor 135a is explained first, and the startup time fuel injection control is explained next, for convenience of explanation, as follows. The function determination routine of FIG. 5 is executed in the case that this routine has never been executed since ignition on (before ignition off) of the hybrid vehicle 20 while the engine 22 is in idle operation after warm up of the engine 22 is completed.

In the function determination routine, the CPU 24a of the engine ECU 24 sets a target air-fuel ratio to a rich air-fuel ratio (for example, value ‘14.1’) that is fuel-richer than a stoichiometric air-fuel ratio (for example, value ‘14.5’, value ‘14.6’, or value ‘14.7’) and start fuel injection control for the function determination (step S300). The CPU 24a starts to measure a time tm1 from value ‘0’ by a timer (now shown) (step S310). The CPU 24a inputs the air-fuel ratio Vaf from the air-fuel ratio sensor 135a and waits until the air-fuel ratio Vaf reaches the target air-fuel ratio (step S320). In the fuel injection control for the function determination of this embodiment, the CPU 24a sets a fuel injection amount corresponding to the intake air amount Qa from the air flow meter 148 so that the air-fuel ratio Vaf from the air-fuel ratio sensor 135a becomes the target air-fuel ratio, and drives the fuel injection valve 126 to be open for a fuel injection time corresponding to the set fuel injection amount.

When the air-fuel ratio Vaf from the air-fuel ratio sensor 135a reaches the target air-fuel ratio, the CPU 24a calculates a delay time Td1(C) by subtracting a normal response time Tdnm1 from the time tm1 (step S330). The delay time Td1(C) represents a reduced degree of responsiveness of the air-fuel ratio sensor 135a (ability of the air-fuel ratio Vaf from air-fuel ratio sensor 135a to track the target air-fuel ratio) in the case where the air-fuel ratio of the engine 22 is changed from the lean air-fuel ratio to the rich air-fuel ratio. The normal response time Tdnm1 may be predetermined by experiment or the like, according to the characteristics of the engine 22 and the air-fuel ratio sensor 135a, as a required time (for example, 300 msec or 500 msec) to bring the air-fuel ratio Vaf from the lean air-fuel ratio to the rich air-fuel ratio when the air-fuel ratio of the engine 22 is changed from the lean air-fuel ratio to the rich air-fuel ratio under a normal condition that the responsiveness of the air-fuel ratio sensor 135a is not reduced. The variable C is set to value ‘1’ as an initial value and incremented by value ‘1’ in the processing described later.

The CPU 24a then inputs the oxygen signal Vo from the oxygen sensor 135b and waits until the oxygen signal Vo indicates a rich-side value in comparison with the stoichiometric air-fuel ratio (step S340). When the oxygen signal Vo indicates the rich-side value, the CPU 24a sets the target air-fuel ratio of the engine 22 to the lean air-fuel ratio and starts the fuel injection control for the function determination (step S350) and starts to measure a time tm2 from the value ‘0’ by the timer (now shown) (step S360). The CPU 24a inputs the air-fuel ratio Vaf from the air-fuel ratio sensor 135a and waits until the air-fuel ratio Vaf reaches the target air-fuel ratio (step S370). When the air-fuel ratio Vaf reaches the target air-fuel ratio, calculates a delay time Td2(C) by subtracting a normal response time Tdnm2 from the time tm2 (step S380) and inputs the oxygen signal Vo from the oxygen sensor 135b to wait until the oxygen signal indicates a lean-side value in comparison with the stoichiometric air-fuel ratio (step S390). The delay time Td2(C) represents a reduced degree of responsiveness of the air-fuel ratio sensor 135a in the case where the air-fuel ratio of the engine 22 is changed from the rich air-fuel ratio to the lean air-fuel ratio. The normal response time Tdnm2 may be predetermined by experiment or the like, according to the characteristics of the engine 22 and the air-fuel ratio sensor 135a, as a required time (for example, 300 msec or 500 msec) to bring the air-fuel ratio Vaf from the rich air-fuel ratio to the lean air-fuel ratio when the air-fuel ratio of the engine 22 is changed from the rich air-fuel ratio to the lean air-fuel ratio under the normal condition that the responsiveness of the air-fuel ratio sensor 135a is not reduced.

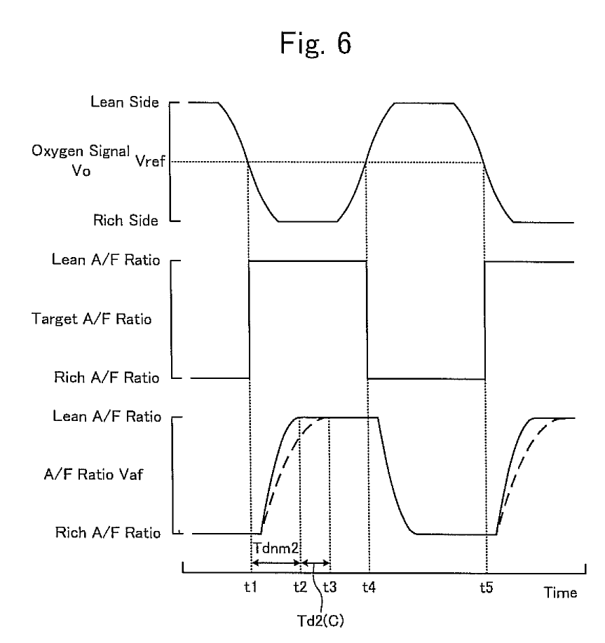

When the oxygen signal Vo indicates the lean-side value, the CPU 24a increments the variable C (step S400) and determines whether the variable C becomes a preset value Cn (step S410). When it is determined that the variable C is not the preset value Cn, the CPU 24a returns to the processing of step S300. The preset value Cn is a predetermined value (for example, value ‘4’ or value ‘6’) as the number of repeated execution of a series of the processing from setting the target air-fuel ratio to the rich air-fuel ratio followed by the oxygen signal Vo reaching the rich-side value until the oxygen signal Vo reaches the lean-side value after setting the target air-fuel ratio to the lean air-fuel ratio. FIG. 6 shows one set of examples of time charts of the oxygen signal Vo and the air-fuel ratio Vaf during execution of the function determination of the air-fuel ratio sensor 135a. In the figure, with regard to the air-fuel ratio Vaf from the air-fuel ratio sensor 135a, the sold line indicates values under the normal condition and the broken line indicates under an abnormal condition where the responsiveness of the air-fuel ratio sensor 135a is reduced in the case of changing the air-fuel ratio of the engine 22 from the rich air-fuel ratio to the lean air-fuel ratio. The target air-fuel ratio is set to the lean air-fuel ratio at the time t1 to perform fuel injection, the air-fuel ratio Vaf becomes the target air-fuel ratio at the time t2 that is later than the time t1 by the normal response time Tdnm2 under the normal condition while becoming the target air-fuel ratio at the time t3 that is further later than the time t2 by the delay time Td2(C) under the abnormal condition. Upon the fuel injection with switching the target air-fuel ratio from the rich air-fuel ratio to the lean air-fuel ratio at the time t1, an excess of oxygen is occluded from the exhaust at the three-way catalyst 134a of the catalytic converter 134, and the oxygen signal Vo switches at the time t4 to a lean-side value crossing the value Vref corresponding to the stoichiometric air-fuel ratio after some time continuing rich-side values. Upon the fuel injection with switching the target air-fuel ratio from the lean air-fuel ratio to the rich air-fuel ratio at the time t4, the occluded oxygen is released to the exhaust at the three-way catalyst 134a of the catalytic converter 134, and the oxygen signal Vo switches at the time t5 to a rich-side value crossing the value Vref after some time continuing lean-side values. The fuel injection is performed again with setting the target air-fuel ratio to the rich air-fuel ratio.

After the calculation of the delay time Td1(C) and the delay time Td2(C) (the variable C is from value ‘1’ through the preset value Cn), the CPU 24a determines the respective averages of the calculated delay time Td1(C) and the delay time Td2(C) and sets them as a lean-rich delay time Td1a and a rich-lean delay time Td2a (step S420). The CPU 24a compares the set lean-rich delay time Td1a with the sum of the normal response time Tdnm1 and a margin ca (step S430). When the lean-rich delay time Td1a is less than the sum of the normal response time Tdnm1 and the margin α1, the CPU 24a sets a lean-rich abnormality flag F1 to value ‘0’ (step S440). When the lean-rich delay time Td1a is more than or equal to the sum of the normal response time Tdnm1 and the margin α1, the CPU 24a sets the lean-rich abnormality flag F2 to value ‘1’ (step S450). The lean-rich abnormality flag F1 is a flag that is set to value ‘0’ upon no occurrence of an abnormality where the responsiveness of the air-fuel ratio sensor 135a is reduced in the case of changing the air-fuel ratio of the engine 22 from the lean air-fuel ratio to the rich air-fuel ratio (hereafter referred to as lean-rich abnormality) and also as an initial value, while being set to value ‘1’ upon occurrence of the lean-rich abnormality, and is stored in a nonvolatile memory (not shown). The margin α1 is used to determine the occurrence of the lean-rich abnormality and may be predetermined as a time (for example, 500 msec or 700 msec) by experiment or the like according to the characteristics of the engine 22 and the air-fuel ratio sensor 135a.

The CPU 24a further compares the set rich-lean delay time Td2a with the sum of the normal response time Tdnm2 and a margin α2 (step S460). When the rich-lean delay time Td2a is less than the sum of the normal response time Tdnm2 and the margin α2, the CPU 24a sets the rich-lean abnormality flag F2 to value ‘0’ (step S480). When the rich-lean delay time Td2a is more than or equal to the sum of the normal response time Tdnm2 and the margin α2, the CPU 24a sets the rich-lean abnormality flag F2 to value ‘1’ (step S490). The CPU 24a then terminates the function determination routine. The rich-lean abnormality flag F2 is a flag that is set to value ‘0’ upon no occurrence of an abnormality where the responsiveness of the air-fuel ratio sensor 135a is reduced in the case of changing the air-fuel ratio of the engine 22 from the rich air-fuel ratio to the lean air-fuel ratio (hereafter referred to as rich-lean abnormality) and also as an initial value, while being set to value ‘1’ upon occurrence of the lean-rich abnormality, and is stored in the nonvolatile memory (not shown). The margin α2 is used to determine the occurrence of the rich-lean abnormality and may be predetermined as a time (for example, 500 msec or 700 msec) by experiment or the like according to the characteristics of the engine 22 and the air-fuel ratio sensor 135a. The above description makes explanation of the function determination of the air-fuel ratio sensor 135a.

The startup time fuel injection control is explained next. The startup time fuel injection control routine of FIG. 4 is executed when the rotation speed Ne of the engine 22 reaches the preset rotation speed, which is to start the fuel injection and the ignition, by the motoring of the engine 22 with the motoring torque from the motor MG1 upon satisfaction of the startup condition of the engine 22.

In the startup time fuel injection control routine, the CPU 24a of the engine ECU 24 inputs various data required for control, for example, the rich-lean abnormality flag F2 and the rich-lean delay time Td2a (step S100) and starts to measure a time tmf from value ‘0’ by the timer (not shown) (step S110). The rich-lean abnormality flag F2 and the rich-lean delay time Td2a may be input by reading the data that is set as results of execution of the function determination routine of the air-fuel ratio sensor 135a of the FIG. 5 and stored in the no volatile memory (not shown).

After the data input, the CPU 24a checks the input rich-lean abnormality flag F2 (step S120). When the rich-lean abnormality flag F2 is equal to value ‘0’, it is determined that the rich-lean abnormality of the air-fuel ratio sensor 135a is not in occurrence and the CPU 24a sets a start time Taf, that is a time from start of the startup time fuel injection control to start of an air-fuel ratio feedback correction when starting the engine 22, to a basic start time Tafb (step S130) and the CPU 24a sets a basic fuel injection amount Qfb (step S150). In this embodiment, the basic fuel injection amount Qfb is set based on the intake air amount Qa from the air flow meter 148 and the rotation speed Ne of the engine 22 as a basic value of fuel injection to bring the air-fuel ratio of the engine 22 to the stoichiometric air-fuel ratio. The basic fuel injection amount Qfb may be set using the cooling water temperature Tw from the water temperature sensor 142, the intake air temperature Ti from the temperature sensor 149, and the throttle position Ta from the throttle valve position sensor 146. The air-fuel ratio feedback correction is performed by correcting the basic fuel injection amount Qfb using feedback control so that the air-fuel ratio Vaf from the air-fuel ratio sensor 135a becomes the stoichiometric air-fuel ratio. The basic start time Tafb is explained later.

After the setting of the start time Taf for the air-fuel ratio feedback correction and the basic fuel injection amount Qfb, the CPU 24a compares the time tmf with the start time Taf (step S160). When the time tmf is less than the start time Taf, the CPU 24a determines that the air-fuel ratio feedback correction is not performed and sets an air-fuel ratio feedback correction factor to value ‘1’ (step S170).

The CPU 24a then compares the time tmf with the increase correction time Tinc that is a time to continue performing increase correction of fuel injection amount (step S200). When the time tmf is less than the increase correction time Tinc, the CPU 24a determines to perform the increase correction and sets an increase correction factor ki to a value larger than value ‘1’ (for example, a gradually decreasing value according to the time tmf or a fixed value) (step S210). In this embodiment, the increase correction time Tinc is duration of the increase correction of the basic fuel injection amount Qfb, and may be predetermined by experiment or the like as a smaller value than the basic start time Tafb of the air-fuel ratio feedback correction. The increase correction is so started together with start of fuel injection as to start up the engine 22 favorably.

After the setting of the air-fuel ratio feedback correction factor kaf and the increase correction factor ki, the CPU 24a calculates a target fuel injection amount Qf* by multiplying the basic fuel injection amount Qfb by the product of the air-fuel ratio feedback correction factor kaf (currently set to value ‘1’) and the increase correction factor ki (currently set to a value larger than value ‘1’) (step S230). The CPU 24a drives the fuel injection valve 126 to be open for a fuel injection time corresponding to the calculated target fuel injection amount Qf* (step S240) and determines whether a termination condition to terminate execution of this routine is satisfied or not (step S250). When the termination condition is not satisfied the CPU 24a returns to the processing of step S150. The termination condition may be, for example, a condition that complete combustion of the engine 22 is determined or a condition that a preset time for shifting to post-startup fuel injection control elapses after startup of the engine 22 is started. Such control enables to perform fuel injection with the increase correction of the basic fuel injection amount Qfb to start up the engine 22 favorably right after start of the fuel injection when starting the engine 22.

When the time tmf is more than or equal to the increase correction time Tinc at the processing of step S200, the CPU 24a sets the increase correction factor ki to value ‘1’ (step S220). The CPU 24a calculates the target fuel injection amount Qf* by multiplying the basic fuel injection amount Qfb by the product of the air-fuel ratio feedback correction factor kaf (currently set to value ‘1’) and the increase correction factor ki (currently set to value ‘1’) (step S230), and drives the fuel injection valve 126 using the calculated target fuel injection amount Qf* (step S240). The CPU 24a then determines whether the termination condition of this routine is satisfied or not (step S250). In this embodiment, the increase correction time Tinc is set to be smaller than the basic start time Tafb, and the air-fuel ratio feedback correction is thus started after finishing the increase correction, as explained next.

When the time tmf is more than or equal to the start time Taf at the processing of step S160, the CPU 24a determines to perform the air-fuel ratio feedback correction and inputs the air-fuel ratio Vaf from the air-fuel ratio sensor 135a (step S180). The CPU 24a sets the air-fuel ratio feedback correction factor kaf, according to Equation (1) given below, using feedback control so that the input air-fuel ratio Vaf becomes the target air-fuel ratio Vaf* set as the stoichiometric air-fuel ratio (step S190) and sets the increase correction factor ki to value ‘1’ (step S200). The CPU 24a then drives the fuel injection valve 126 using the target fuel injection amount Qf* calculated from multiplying the basic fuel injection amount Qfb by the product of the air-fuel ratio feedback correction factor kaf and the increase correction factor ki (currently set to value ‘1’) (step S230 and S240) and determines whether the termination condition of this routine is satisfied or not (step S250). Upon determination of the termination condition, the CPU 24a terminates the startup time fuel injection control routine:

kaf=kaf+k1(Vaf*−Vaf)+k2∫(Vaf*−Vaf)dt (1)

In Equation (1) given above, the first term on the right side denotes the air-fuel ratio feedback correction factor kaf that is set by the present time, and ‘k1’ in the second term and ‘k2’ in the third term on the right side respectively denote a gain of the proportional and a gain of the integral term. Upon termination of the startup time fuel injection control routine, a fuel injection control routine for a post-startup time (not shown) is executed. The basic start time Tafb that the start time Taf is set to is explained here. In this embodiment, the basic start time Tafb is predetermined by experiment or the like as a timing that the air-fuel ratio Vaf detected by the air-fuel ratio sensor 135a reaches the target air-fuel ratio Vaf* as the stoichiometric air-fuel ratio after finishing the increase correction of the basic fuel injection amount Qfb under the normal condition for the air-fuel ratio sensor 135a (under a condition that there is no occurrence of the lean-rich abnormality and the rich-lean abnormality of the air-fuel ratio sensor 135a). Accordingly, when the rich-lean abnormality flag F2 is equal to value ‘0’ denoting no occurrence of the rich-lean abnormality of the air-fuel ratio sensor 135a, the air-fuel ratio feedback correction of the basic fuel injection amount Qfb is started at a timing when this basic start time Tafb elapses after starting execution of the startup time fuel injection control routine. It is thus prevented that the air-fuel ratio feedback correction is started in a state that the air-fuel ratio Vaf from the air-fuel ratio sensor 135a deviates from the target air-fuel ratio Vaf* as the stoichiometric air-fuel ratio, and divergence of the air-fuel ratio of the engine 22 is effectively prevented.

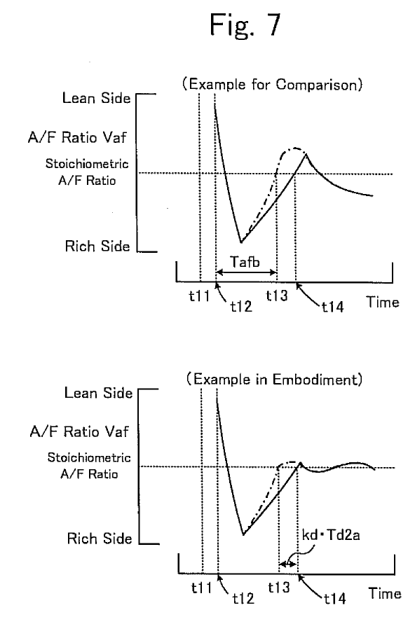

When the rich-lean abnormality flag F2 is equal to value ‘1’ at the processing of step S120, it is determined that the rich-lean abnormality of the air-fuel ratio sensor 135a is in occurrence, and the CPU 24a sets the sum of the basic start time Tafb and the product of the rich-lean delay time Td2a and a conversion factor kd as the start time Taf that is a time from start of the startup time fuel injection control for startup of the engine 22 to start of the air-fuel ratio feedback correction (step S140) and sets the basic fuel injection amount Qfb (step S150). The CPU 24a then perform fuel injection using the increase correction factor ki and the air-fuel ratio feedback correction factor kaf respectively set according to the elapsed time tmf from start of the startup time fuel injection control (step S160 through S240), and terminates the startup time fuel injection control routine upon determination of satisfaction of the termination condition of this routine. The conversion factor kd is a factor to convert the rich-lean delay time Td2a into a response delay time against the normal condition of the air-fuel ratio sensor 135a, and is predetermined by experiment or the like. The response delay time occurs until the air-fuel ratio Vaf from the air-fuel ratio sensor 135a with rich-lean abnormality reaches the target air-fuel ratio Vaf* after finishing the increase correction. FIG. 7 shows one set of examples of time charts of the air-fuel ratio of the engine 22 without occurrence of the lean-rich abnormality but with occurrence of the rich-lean abnormality of the air-fuel ratio sensor 135a. In the figure, the solid line indicates the air-fuel ratio Vaf detected by the air-fuel ratio sensor 135a and the alternate long and short dashed line indicates the actual air-fuel ratio of the engine 22 (the air-fuel ratio Vaf that is assumed to be detected by the air-fuel ratio sensor 135a under its normal condition). In the figure, the lower chart shows the exemplified case of this embodiment where the sum of the basic start time Tafb and the rich-lean delay time Td2a is used as the start time Taf for the air-fuel ratio feedback correction, and the upper chart shows an exemplified case for comparison where the basic start time Tafb is used as the start time Taf for the air-fuel ratio feedback correction. Motoring of the engine 22 with the motor MG1 is started at the time t11 and the fuel injection into the engine 22 is started at the time t12. The air-fuel ratio Vaf from the air-fuel ratio sensor 135a changes from a leaner side value to a richer side value than the stoichiometric air-fuel ratio accompanied by the increase correction of the basic fuel injection amount Qfb of the engine 22. The air-fuel ratio Vaf from the air-fuel ratio sensor 135a gradually approaches the stoichiometric air-fuel ratio after finishing the increase correction. In the case for comparison, the air-fuel ratio feedback correction is started at the time t13 when the basic start time Tafb elapses from the time t12, and the air-fuel ratio feedback correction is started using the air-fuel ratio Vaf (having a richer side value at the time t13) from the air-fuel ratio sensor 135a with its rich-lean abnormality. As shown by the alternate long and short dashed line, the fuel injection amount is corrected toward the decrease side although the actual air-fuel ratio is close to the stoichiometric air-fuel ratio, and the actual air-fuel ratio of the engine 22 becomes a lean side value. For this reason, the emission of the exhaust is worsened, for example, by discharging nitrogen oxides (NOx), every time the engine 22 is started up during the intermittent operation of the engine 22. Therefore, in this embodiment, the air-fuel ratio feedback correction is started at the time t14 later than the time t13, and it thus is prevented that the emission of the exhaust is worsened. Moreover, in this embodiment, the air-fuel ratio feedback correction is started at the timing of the time t14 when the sum of the basic start time Tafb and the product of the rich-lean delay time Td2a and the conversion factor kd elapses from the time t12, and this arrangement enables to start the air-fuel ratio feedback correction at a timing on which a response delay time, due to the rich-lean abnormality in occurrence at the air-fuel ratio sensor 135a, is reflected. As a result, the exhaust emission is effectively prevented from becoming worse using the result of the function determination of the air-fuel ratio sensor 135a.

In the hybrid vehicle 20 of the embodiment described above, the CPU 24a performs the function determination of the air-fuel ratio sensor 135a including determination whether there occurs the rich-lean abnormality that is an abnormality where the air-fuel ratio sensor 135a becomes less responsive to a change in the air-fuel ratio of the engine 22 from the rich air-fuel ratio to the lean air-fuel ratio. When the engine 22 is started up with motoring by the motor MG1 while the rich-lean abnormality is not determined, that is, while the rich-lean abnormality flag F2 is equal to value ‘0’, the air-fuel ratio feedback correction for fuel injection into the engine 22 is started at the timing when the basic start time Tafb elapses from the start of fuel injection after finishing the increase correction at the timing when the increase correction time Tinc elapses from the start of fuel injection. When the engine 22 is started up with motoring by the motor MG1 while the rich-lean abnormality is determined, that is, while the rich-lean abnormality flag F2 is equal to value ‘1’, the air-fuel ratio feedback correction for fuel injection into the engine 22 is started at a later timing than the timing when the basic start time Tafb elapses from the start of fuel injection after finishing the increase correction at the timing when the increase correction time Tinc elapses from the start of fuel injection. Accordingly, it is effectively prevented the exhaust emission from becoming worse using the result of the function determination of the air-fuel ratio sensor 135a.

In the hybrid vehicle 20 of the embodiment, the start time Taf of the air-fuel ratio feedback correction is set to the basic start time Tafb when the rich-lean abnormality flag F2 is equal to value ‘0’, and the start time Taf of the start time Taf of the air-fuel ratio feedback correction is set to the sum of the basic start time Tafb and the product of the rich-lean delay time Td2a and the conversion factor kd when the rich-lean abnormality flag F2 is equal to value ‘1’ . Instead, the start time Taf of the air-fuel ratio feedback correction may be set to the basic start time Tafb when the rich-lean abnormality flag F2 is equal to value ‘0’ as well as the lean-rich abnormality flag F1 is equal to value ‘0’, and the start time Taf of the start time Taf of the air-fuel ratio feedback correction may be set to the sum of the basic start time Tafb and the product of the rich-lean delay time Td2a and the conversion factor kd when the rich-lean abnormality flag F2 is equal to value ‘1’ as well as the lean-rich abnormality flag F1 is equal to value ‘0’.

In the hybrid vehicle 20 of the embodiment, the start time Taf of the air-fuel ratio feedback correction is set to the sum of the basic start time Tafb and the product of the rich-lean delay time Td2a and the conversion factor kd when the rich-lean abnormality flag F2 is equal to value ‘1’, and the rich-lean delay time Td2a is set as an average of the delay time Td2(C) in the function determination routine of the air-fuel ratio sensor 135a. Instead, the rich-lean delay time Td2a may be set as a maximum value or a median value of the delay time Td2(C) in the function determination routine of the air-fuel ratio sensor 135a. The start time Taf of the air-fuel ratio feedback correction may be set to the sum of the basic start time Tafb and a preset time that is, for example, a fixed value obtained by experiment or the like as a response delay time against the air-fuel ratio sensor 135a with its normal condition when the rich-lean abnormality of the air-fuel ratio sensor 135a is in occurrence.

In the hybrid vehicle 20 of the embodiment, the basic start time Tafb is predetermined by experiment or the like as a timing that the air-fuel ratio Vaf detected by the air-fuel ratio sensor 135a reaches the target air-fuel ratio Vaf* as the stoichiometric air-fuel ratio after finishing the increase correction of the basic fuel injection amount Qfb under the normal condition for the air-fuel ratio sensor 135a. Instead, the basic start time Tafb may be predetermined by experiment or the like as a timing that the air-fuel ratio Vaf detected by the air-fuel ratio sensor 135a reaches a target air-fuel ratio range (for example, a range of the air-fuel ratio more than or equal to value ‘14.5’ and less than or equal to value ‘14.7’) after finishing the increase correction of the basic fuel injection amount Qfb under the normal condition for the air-fuel ratio sensor 135a.

In the hybrid vehicle 20 of the embodiment, the increase correction is finished at the timing when the increase correction time Tinc elapses from the start of fuel injection, and the air-fuel ratio feedback correction is started at the timing when the start time Taf elapses from the start of fuel injection. Instead, the increase correction may be finished at the timing when a preset increase correction finish time elapses from the start of engine 22 startup (for example, the timing when a startup condition is satisfied or the timing when the motoring of the engine 22 is started), and the air-fuel ratio feedback correction may be started at the timing when a preset start time elapses from the start of engine 22 startup.

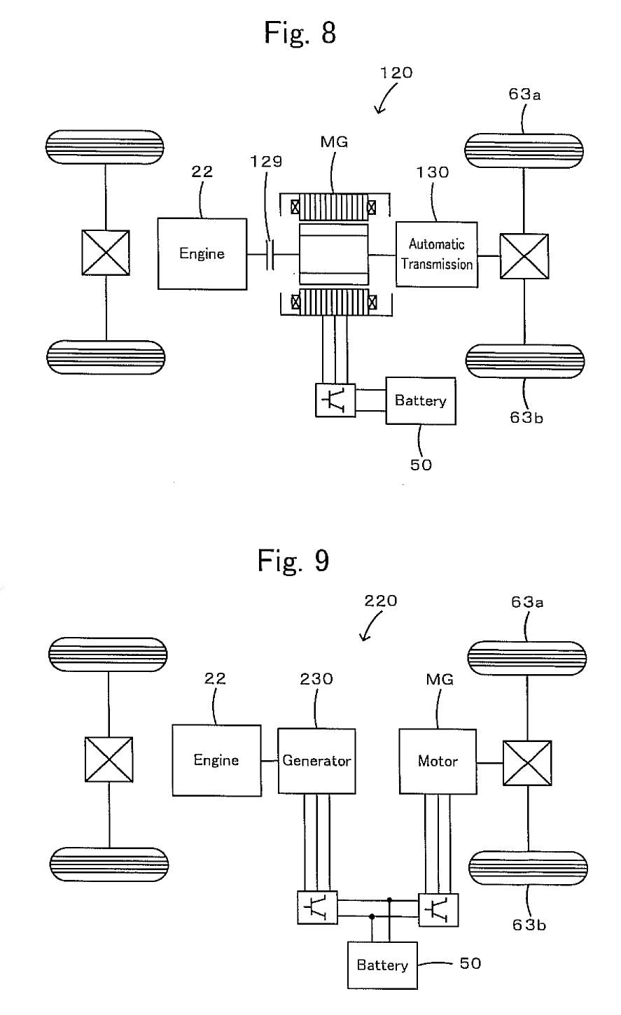

In the hybrid vehicle 20 of the embodiment, the power of the engine 22 is output via the power distribution integration mechanism 30 to the side of the drive wheels 63a and 63b and the power of the motor MG2 is output to the side of the drive wheels 63a and 63b. The technique of the invention is also applicable to a hybrid vehicle 120 a modified structure shown in FIG. 8. In the hybrid vehicle 120 of FIG. 8, a motor MG is connected via an automatic transmission 130 to the driveshaft linked to the drive wheels 63a and 63, and the engine 22 is connected via a clutch 129 to the rotating shaft of the motor MG. In the hybrid vehicle 120, the power of the engine 22 is output via the rotating shaft of the motor MG and the automatic transmission to the side of drive wheels 63a and 63b, and the power of the motor MG is output via the automatic transmission to the side of drive wheels 63a and 63. In this case, the motor MG corresponds to a motor which the engine 22 is cranked by. The technique of the invention is also applicable to a hybrid vehicle 220 of another modified structure shown in FIG. 9. The hybrid vehicle 220 of FIG. 9 has a generator 230 that generates electric power with the power of the engine 22 and a motor MG connected to the driveshaft linked to the drive wheels 63a and 63b. In the hybrid vehicle 220, the battery 50 is charged and discharged with power generation by the generator 230 using the power from the engine 22, and the power of the motor MG using the electric power of the generator 230 and the battery 50 is output to the side of drive wheels 63a and 63b with the charge and discharge of the battery 50. In this case, the generator 230 corresponds to a motor which the engine 22 is cranked by. The technique of the invention is also applicable to a motor vehicle that does not have a motor to output a driving power and only the power of the engine 22 is output via an automatic transmission to the drive wheels.

The embodiment regards application to the hybrid vehicle. The principle of the invention may be actualized by an internal combustion engine system installed in diversity of other applications, for example, mobile bodies such as vehicles other than automobiles, boats and ships, and aircrafts, and may also be installed in fixed equipments such as construction equipments. The principle of the invention may be actualized by a fuel injection control method of an internal combustion engine included in an internal combustion engine system.

The primary elements in the embodiment and its modified examples are mapped to the primary constituents in the claims of the invention as described below. The engine 22 in the embodiment corresponds to the ‘internal combustion engine’ in the claims of the invention. The motor MG1 in the embodiment corresponds to the ‘motor’ in the claims of the invention. The fuel injection value 126 in the embodiment corresponds to the ‘fuel injector’ in the claims of the invention. The air-fuel ratio sensor 135a corresponds to the ‘air-fuel ratio detector’ in the claims of the invention. The engine ECU 24 executing the processing in the function determination routine of FIG. 5 to perform the function determination of the air-fuel ratio sensor 135a including determination whether the rich-lean abnormality of the air-fuel ratio sensor 135a is in occurrence or not corresponds to the ‘air-fuel ratio detecting function determination module’ in the claims of the invention. The engine ECU 24 executing the processing of step S100 through S230 in the startup time fuel injection control routine of FIG. 4 to calculate the target fuel injection amount Qf*, when the engine 22 is started up with motoring by the motor MG1 while the rich-lean abnormality flag F2 is equal to value ‘0’, with the air-fuel ratio feedback correction started at the timing when the basic start time Tafb elapses from the start of fuel injection after the increase correction finished at the timing when the increase correction time Tinc elapses from the start of fuel injection, and calculate the target fuel injection amount Qf*, when the engine 22 is started up with motoring by the motor MG1 while the rich-lean abnormality flag F2 is equal to value ‘1’, with the air-fuel ratio feedback correction started at a later timing than the timing when the basic start time Tafb elapses from the start of fuel injection after the increase correction finished at the timing when the increase correction time Tinc elapses from the start of fuel injection corresponds to the ‘target fuel injection amount setting module’ in the claims of the invention. The engine ECU 24 executing the processing of step S240 in the startup time fuel injection control routine of FIG. 4 to drive the fuel injection valve 126 to be open for the fuel injection time which corresponds to the calculated target fuel injection amount Qf* corresponds to the ‘fuel injection control module’ in the claims of the invention. The motor MG2 in the embodiment corresponds to the ‘second motor’ in the claims of the invention.

The ‘internal combustion engine’ is not restricted to the engine 22 designed to consume a hydrocarbon fuel, such as gasoline or light oil, and thereby output power, but may be an internal combustion engine of any other design. The ‘motor’ is not restricted to the motor MG1 constructed as a synchronous motor generator but may be any type of motor capable of cranking the internal combustion engine, for example, an induction motor. The ‘fuel injector’ is not restricted to the fuel injection valve 126 but may be any other unit that performs fuel injection into the internal combustion engine. The ‘air-fuel ratio detector’ is not restricted to the air-fuel ratio sensor 135a but any other unit that detects an air-fuel ratio of the internal combustion engine. The ‘air-fuel ratio detecting function determination module’ is not restricted to the arrangement of performing the function determination of the air-fuel ratio sensor 135a including determination whether the rich-lean abnormality of the air-fuel ratio sensor 135a is in occurrence or not, but may be any other arrangement of performing function determination of the air-fuel detector, the function determination including detection of a responsiveness reduction abnormality that is an abnormality where the air-fuel ratio detector becomes less responsive to a change in the air-fuel ratio of the internal combustion engine from a rich air-fuel ratio to a lean air-fuel ratio, the rich air-fuel ratio being fuel-richer and the lean air-fuel ratio being fuel-leaner both in comparison with a stoichiometric air-fuel ratio. The ‘target fuel injection amount setting module’ is not restricted to the arrangement of calculating the target fuel injection amount Qf*, when the engine 22 is started up with motoring by the motor MG1 while the rich-lean abnormality flag F2 is equal to value ‘0’, with the air-fuel ratio feedback correction started at the timing when the basic start time Tafb elapses from the start of fuel injection after the increase correction finished at the timing when the increase correction time Tinc elapses from the start of fuel injection, and calculating the target fuel injection amount Qf*, when the engine 22 is started up with motoring by the motor MG1 while the rich-lean abnormality flag F2 is equal to value ‘1’, with the air-fuel ratio feedback correction started at a later timing than the timing when the basic start time Tafb elapses from the start of fuel injection after the increase correction finished at the timing when the increase correction time Tinc elapses from the start of fuel injection, but any other arrangement of, when the internal combustion engine is cranked by the motor and started up while the responsiveness reduction abnormality is not detected, setting a target fuel injection amount to be injected into the internal combustion engine by applying an increase correction to a basic fuel injection amount until a preset timing that is predetermined so that the internal combustion engine is favorably combusted, the basic fuel injection amount being a fuel injection amount based on an intake air amount of the internal combustion engine for bringing the air-fuel ratio of the internal combustion engine to the stoichiometric air-fuel ratio, and then setting the target fuel injection amount by performing an air-fuel ratio feedback correction from a first start timing that is predetermined as a timing when the detected air-fuel ratio by the air-fuel ratio detector reaches a target air-fuel ratio range including the stoichiometric air-fuel ratio without occurrence of the responsiveness reduction abnormality after finishing the increase correction, the air-fuel ratio feedback correction being a correction of the basic fuel injection amount using feedback control for bringing the detected air-fuel ratio by the air-fuel ratio detector to the stoichiometric air-fuel ratio, and when the internal combustion engine is cranked by the motor and started up while the responsiveness reduction abnormality is detected, the target fuel injection amount setting module setting the target fuel injection amount by applying the increase correction to the basic fuel injection amount until the preset timing, and then setting the target fuel injection amount by performing the air-fuel ratio feedback correction from a second start timing that is later than the first start timing. The ‘fuel injection control module’ is not restricted to the arrangement of driving the fuel injection valve 126 to be open for the fuel injection time which corresponds to the calculated target fuel injection amount Qf*, but any other arrangement of controlling the fuel injector so that the fuel injection into the internal combustion engine is performed according the set target fuel injection amount. The ‘second motor’ is not restricted to the motor MG2 constructed as a synchronous motor generator but may be any type of motor capable of outputting power for driving the vehicle, for example, an induction motor.

The above mapping of the primary elements in the embodiment and its modified examples to the primary constituents in the claims of the invention is not restrictive in any sense but is only illustrative for concretely describing the modes of carrying out the invention. Namely the embodiment and its modified examples discussed above are to be considered in all aspects as illustrative and not restrictive.

There may be many other modifications, changes, and alterations without departing from the scope or spirit of the main characteristics of the present invention.

The technique of the invention is preferably applied to the manufacturing industries of the internal combustion engine systems.

1. An internal combustion engine system having an internal combustion engine and a motor capable of cranking the internal combustion engine, the internal combustion engine system comprising:
a fuel injector that performs fuel injection into the internal combustion engine;
an air-fuel ratio detector that detects an air-fuel ratio of the internal combustion engine;
an air-fuel ratio detecting function determination module that performs function determination of the air-fuel ratio detector, the function determination including detection of a responsiveness reduction abnormality that is an abnormality where the air-fuel ratio detector becomes less responsive to a change in the air-fuel ratio of the internal combustion engine from a rich air-fuel ratio to a lean air-fuel ratio, the rich air-fuel ratio being fuel-richer and the lean air-fuel ratio being fuel-leaner both in comparison with a stoichiometric air-fuel ratio;
a target fuel injection amount setting module that, when the internal combustion engine is cranked by the motor and started up while the responsiveness reduction abnormality is not detected, sets a target fuel injection amount to be injected into the internal combustion engine by applying an increase correction to a basic fuel injection amount until a preset timing that is predetermined so that the internal combustion engine is favorably combusted, the basic fuel injection amount being a fuel injection amount based on an intake air amount of the internal combustion engine for bringing the air-fuel ratio of the internal combustion engine to the stoichiometric air-fuel ratio,
and then sets the target fuel injection amount by performing an air-fuel ratio feedback correction from a first start timing that is predetermined as a timing when the detected air-fuel ratio by the air-fuel ratio detector reaches a target air-fuel ratio range including the stoichiometric air-fuel ratio without occurrence of the responsiveness reduction abnormality after finishing the increase correction, the air-fuel ratio feedback correction being a correction of the basic fuel injection amount using feedback control for bringing the detected air-fuel ratio by the air-fuel ratio detector to the stoichiometric air-fuel ratio, and
when the internal combustion engine is cranked by the motor and started up while the responsiveness reduction abnormality is detected, the target fuel injection amount setting module setting the target fuel injection amount by applying the increase correction to the basic fuel injection amount until the preset timing, and then setting the target fuel injection amount by performing the air-fuel ratio feedback correction from a second start timing that is later than the first start timing; and
a fuel injection control module that controls the fuel injector so that the fuel injection into the internal combustion engine is performed according the set target fuel injection amount.

2. The internal combustion engine system in accordance with claim 1, wherein the air-fuel ratio detecting function determination module detects a reduced degree of responsiveness of the air-fuel ratio detector as a delay time upon the detection of the responsiveness reduction abnormality, and
the target fuel injection amount setting module sets, when the internal combustion engine is cranked by the motor and started up while the responsiveness reduction abnormality is detected, the target fuel injection amount using a later timing by a corresponding time to the detected delay time than the first start timing as the second start timing.

3. A vehicle having the internal combustion engine system in accordance with claim 1 and a second motor capable of outputting power for driving the vehicle, the vehicle being driven with an intermittent operation of the internal combustion engine.

4. A fuel injection control method of an internal combustion engine in an internal combustion engine system having the internal combustion engine, a fuel injector that performs fuel injection into the internal combustion engine, an air-fuel ratio detector that detects an air-fuel ratio of the internal combustion engine, and a motor capable of cranking the internal combustion engine, the fuel injection control method comprising:
performing function determination of the air-fuel ratio detector, the function determination including detection of a responsiveness reduction abnormality that is an abnormality where the air-fuel ratio detector becomes less responsive to a change in the air-fuel ratio of the internal combustion engine from a rich air-fuel ratio to a lean air-fuel ratio, the rich air-fuel ratio being fuel-richer and the lean air-fuel ratio being fuel-leaner both in comparison with a stoichiometric air-fuel ratio;
when the internal combustion engine is cranked by the motor and started up while the responsiveness reduction abnormality is not detected, setting a target fuel injection amount to be injected into the internal combustion engine by applying an increase correction to a basic fuel injection amount until a preset timing that is predetermined so that the internal combustion engine is favorably combusted, the basic fuel injection amount being a fuel injection amount based on an intake air amount of the internal combustion engine for bringing the air-fuel ratio of the internal combustion engine to the stoichiometric air-fuel ratio,
and then setting the target fuel injection amount by performing an air-fuel ratio feedback correction from a first start timing that is predetermined as a timing when the detected air-fuel ratio by the air-fuel ratio detector reaches a target air-fuel ratio range including the stoichiometric air-fuel ratio without occurrence of the responsiveness reduction abnormality after finishing the increase correction, the air-fuel ratio feedback correction being a correction of the basic fuel injection amount using feedback control for bringing the detected air-fuel ratio by the air-fuel ratio detector to the stoichiometric air-fuel ratio, and
when the internal combustion engine is cranked by the motor and started up while the responsiveness reduction abnormality is detected, setting the target fuel injection amount by applying the increase correction to the basic fuel injection amount until the preset timing, and then setting the target fuel injection amount by performing the air-fuel ratio feedback correction from a second start timing that is later than the first start timing; and
controlling the fuel injector so that the fuel injection into the internal combustion engine is performed according the set target fuel injection amount.
